(19) United States
(12) Patent Application Publication
(10) Pub. No.: US 2012/0188226 A1
(43) Pub. Date: Jul. 26, 2012

(54) METHOD AND SYSTEM FOR DISPLAYING STEREOSCOPIC IMAGES

(76) Inventors: Lin-Kai Bu, Tainan County (TW); Wen-Jen Huang, Tainan County (TW)

(21) Appl. No.: 13/010,788

(22) Filed: Jan. 21, 2011

(51) Int. Cl. G06T 15/00

(52) U.S. Cl. 345/419

(57) ABSTRACT

A method for displaying stereoscopic images is provided. A parallax bound and a plurality of depth ranges are calculated according to at least one environmental parameter. The user may select a depth range among the plurality of depth ranges. A depth of a stereoscopic image is adjusted according to the parallax bound and the selected depth range. Stereoscopic images are then displayed on a screen of a 3D display device according to the adjusted depth.

### BACKGROUND OF THE INVENTION

1. Field of the Invention

The present invention is related to a method and a system for displaying stereoscopic images, and more particularly, a method and a system for displaying stereoscopic images without causing visual discomforts.

2. Description of the Prior Art

Three-dimensional (3D) display technology provides more vivid visual experiences than traditional two-dimensional (2D) display technology. Stereoscopic displays are designed to provide the visual system with the horizontal disparity cue by displaying a different image to each eye. Known 3D display systems typically display a different image to each of the observers' two eyes by separating them in time, wavelength or space. There are two major types of 3D viewing environments: glasses-type and auto-stereoscopic. In glasses-type 3D display systems, 3D viewing devices are required to creating the illusion of stereoscopic images from planer images, such as using liquid crystal shutter glasses to separate the two images in time, or color filters of anaglyph glasses or polarizing glasses to separate the two images based on optical properties. Auto-stereoscopic 3D display systems include using lenticular screens, barrier screens or auto-stereoscopic projection to separate the two images in space, thereby directly evoking stereoscopic effect.

When viewing an object in the real world, the axes of the human eyes rotate to meet at the desired location. Convergence is the simultaneous inward movement of both eyes towards each other in order to maintain single binocular vision when viewing a near object and divergence is the simultaneous outward movement of both eyes away from each other in order to maintain single binocular vision when viewing a distant object. The angle of convergence or divergence varies depending on the distance between the eyes and the object of interest. When looking at a distant object such as the sun, the axes of the eyes may be considered to be parallel due to the small angle of convergence.

Accommodation is the adjustment in the focal length of the lens of the eye for maintaining a clear image focus on the retina as an object draws close to or away from the eyes. When viewing a distant object, the ciliary muscles holding the lens contract, thereby thinning the lens in order to bring the distant object into clearer focus on the back of the retina. When viewing a near object, the ciliary muscles holding the lens relax, thereby thickening the lens in order to bring the near object into focus.

An auto-stereoscopic 3D display device, normally positioned in a fixed location, needs to produce a disparity in the eyes in order to fool the brain into perceiving an image at an artificial distance (which differs from the disparity that would be associated with an observation of the corresponding object in the real-world). 3D perception is achieved by producing a parallax in which accommodation and convergence may be mismatched. This kind of accommodation-convergence conflict may lead to visual discomfort.

FIGS. 1A-1D illustrate four types of parallax which can be used on an auto-stereoscopic 3D display device. FIG. 1A illustrates zero parallax in which the eyes converge at the same point, the exact scenario when viewing when viewing an object in the real world. For an auto-stereoscopic 3D display device, zero parallax means that the images are being formed on the screen surface. In this case, accommodation and convergence of the eyes are both at the same point, thereby providing the most natural and comfortable viewing environment.

FIG. 1B illustrates positive parallax in which the eye axes are between zero parallax and parallel parallax (i.e. the eye axes are parallel as if viewing a very distant object), giving the appearance of objects going into the screen. Convergence is fixed at a stereoscopic image formed behind the screen surface, while accommodation is still at the screen surface. This relationship between convergence and accommodation in order to simulate real world viewing may cause visual discomfort to some people.

FIG. 1C illustrates divergent parallax in which the eyes do not converge on an object and actually diverge as the name suggests. Divergent parallax may occur if the separation of the left and right images on the screen exceeds the interpupillary distance of a viewer. This unnatural eye position causes discomfort and should best be avoided when producing stereoscopic images.

FIG. 1D illustrates negative parallax in which stereoscopic images are projected/displayed between the accommodated surface (i.e. the screen) and the viewer's eye position, giving the appearance of objects coming out of the screen. The user still focuses on the screen, but the eyes converge in front of it. This relationship between convergence and accommodation in order to simulate real world viewing may cause visual discomfort to some people.

These parallax techniques allow the images to be correctly projected in front or behind the screen surface, within the physical limits of eye movement. The association between convergence and accommodation is habitual as it is used when a person views an object in normal circumstances. Choosing the lowest possible parallax value that still gives the required sense of depth is the best method of minimizing any breakdown of the stereoscopic effect. However, the default parallax of a 3D display device may cause visual discomfort to some people. Also, the default parallax may not always be optimized since human eyes vary in interpupillary distance and a viewer may change his position during a 3D presentation. It is therefore a need for a stereoscopic image display method which provides a customized display parameter based on current viewing environment in order or avoiding causing visual discomforts.

### SUMMARY OF THE INVENTION

The present invention provides a method for displaying stereoscopic images. The method includes providing a parallax bound and a plurality of depth ranges according to at least one environmental parameter; selecting a depth range among the plurality of depth ranges; adjusting a depth of a stereoscopic image according to the parallax bound and the selected depth range; and displaying the adjusted stereoscopic image on a screen.

The present invention also provides method for displaying multi-view stereoscopic images. The method includes providing two or more parallax bounds and two or more sets of depth ranges respectively according to two or more sets of at least one environmental parameter which are associated with different viewing locations respectively; selecting two or more depth ranges respectively from the two or more sets of depth ranges; and adjusting the depth of a multi-viewing stereoscopic image to be presented for each viewing location according to the two or more parallax bounds and the two or more selected depth ranges; and displaying the adjusted multi-viewing stereoscopic image on a screen.

The present invention also provides a system for displaying stereoscopic images. The system includes an interface configured to allow a user to set at least one environmental parameter; a depth adjusting module configured to provide the plurality of depth ranges and a parallax bound according to the at least one environmental parameter and adjust a depth of a stereoscopic image according to the parallax bound and the selected depth range; and a screen configured to display the adjusted stereoscopic image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A-1D are diagrams illustrating four types of parallax.

FIGS. 2 and 3 are flowcharts illustrating a method for displaying stereoscopic images according to embodiments of the present invention.

FIG. 4 is a diagram illustrating the method for displaying stereoscopic images according to the present invention.

FIG. 5 is a diagram illustrating a 3D display system according to the present invention.

FIG. 6 is a diagram illustrating the present invention when used in a multi-view 3D display system.

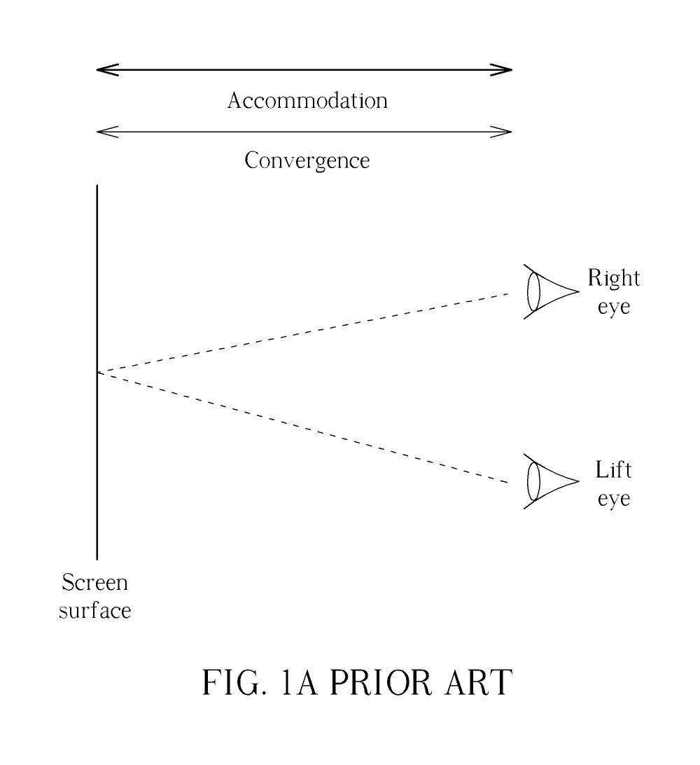

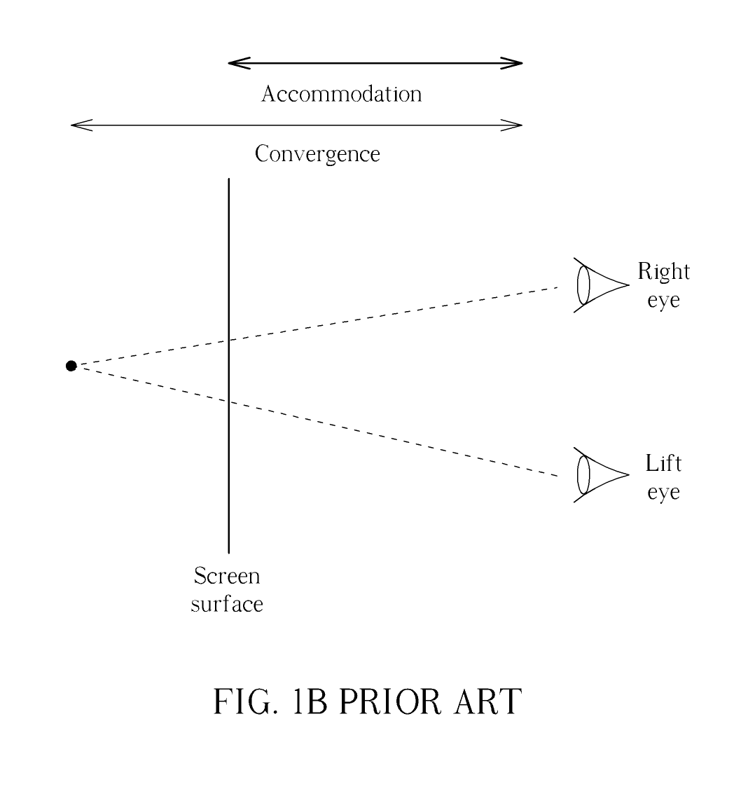

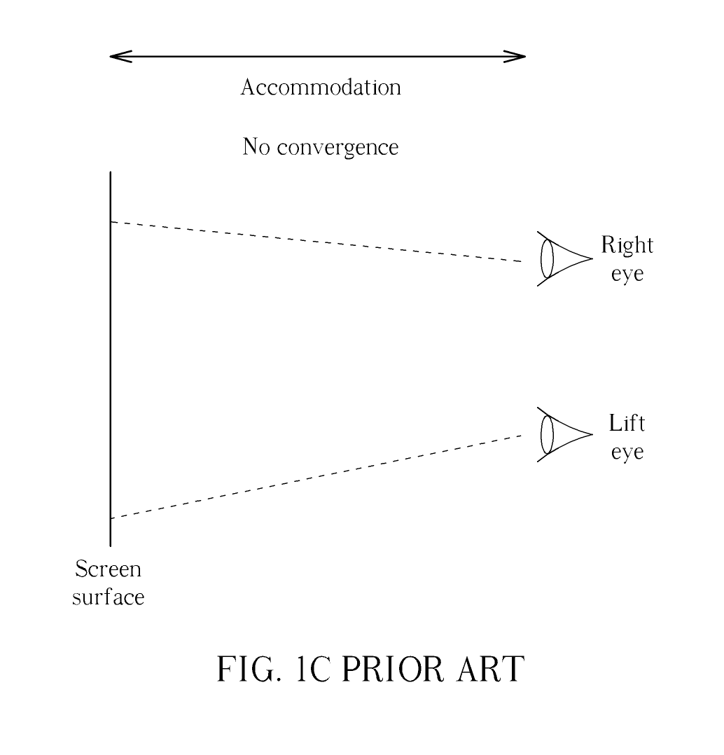

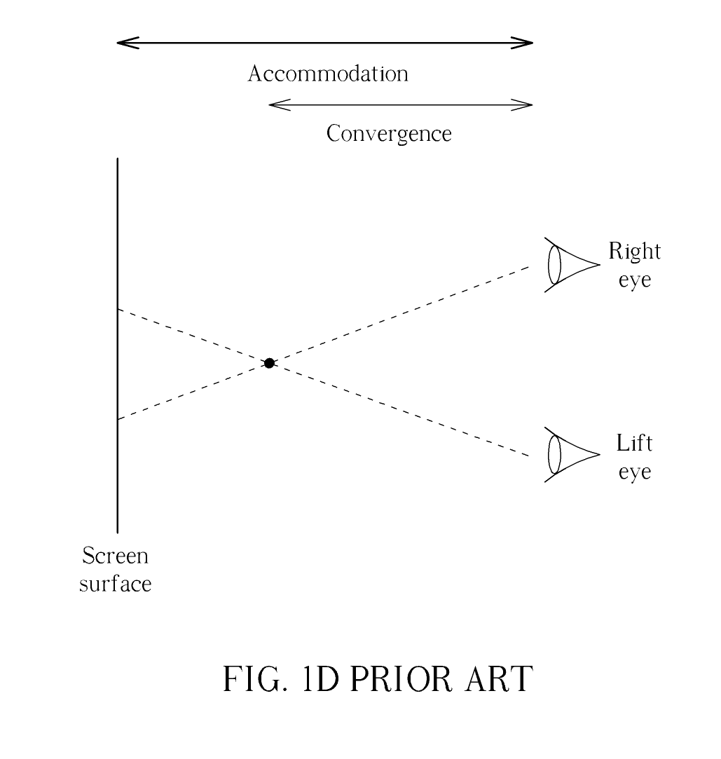

### DETAILED DESCRIPTION

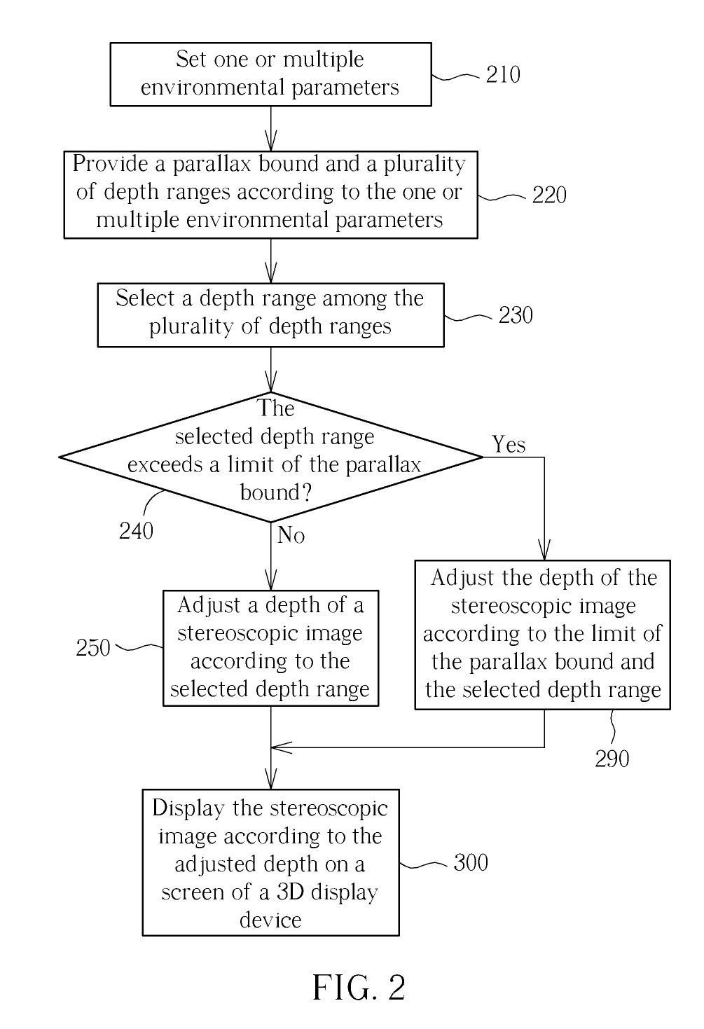

FIG. 2 is a flowchart illustrating a method for displaying stereoscopic images according to a first embodiment of the present invention. The present method in FIG. 2 includes the following steps:

Step 210: allow a user to set one or multiple environmental parameters;

Step 220: provide a parallax bound and a plurality of depth ranges according to the one or multiple environmental parameters;

Step 230: allow the user to select a depth range among the plurality of depth ranges;

Step 240: determine whether the selected depth range exceeds a limit of the parallax bound; if yes, execute step 290; if no, execute step 250;

Step 250: adjust a depth of a stereoscopic image according to the selected depth range; execute step 300;

Step 290: adjust the depth of the stereoscopic image according to the limit of the parallax bound and the selected depth range; execute step 300;

Step 300: display the stereoscopic image according to the adjusted depth on a screen of a 3D display device.

In step 210, the one of more environmental parameters of concern may include the interpupillary distance of the user, the spatial width/spatial length/resolution of the 3D display device, or the distance between the current viewing location and the screen of the 3D display device.

In step 220, the parallax bound may be calculated according to the one or more environmental parameters which may be associated with the optometric features of the user or the disposition of the 3D viewing environment. For example, the average distance between human eyes is about 6.5 cm, but the interpupillary distance of each individual may vary. There maybe various models of 3D display devices each having a different spatial width, spatial length or resolution. Also, the distance between the user and the screen of the 3D display device may also vary if the user changes his position during a 3D presentation. The interpupillary distance, the configuration and performance of the 3D display device and the viewing distance are examples of the environmental parameter which determines the optimized parallax bound for a certain individual in a certain viewing environment.

In step 230, the user may select a depth range among the plurality of depth ranges based on personal preference via an interface.

If it is determined in step 240 that the selected depth range does not exceed the limit of the parallax bound, step 250 is executed for adjusting the depth of the stereoscopic image according to the selected depth range.

If images are displayed according to the selected depth range which is outside the parallax bound, visual discomfort may be provoked. Therefore, if it is determined in step 240 that the selected depth range exceeds the limit of the parallax bound, step 290 is executed for adjusting the depth of the stereoscopic image according to the limit of the parallax bound and the selected depth range.

In Step 300, the stereoscopic images are displayed according to the adjusted depth on the screen of the 3D display device.

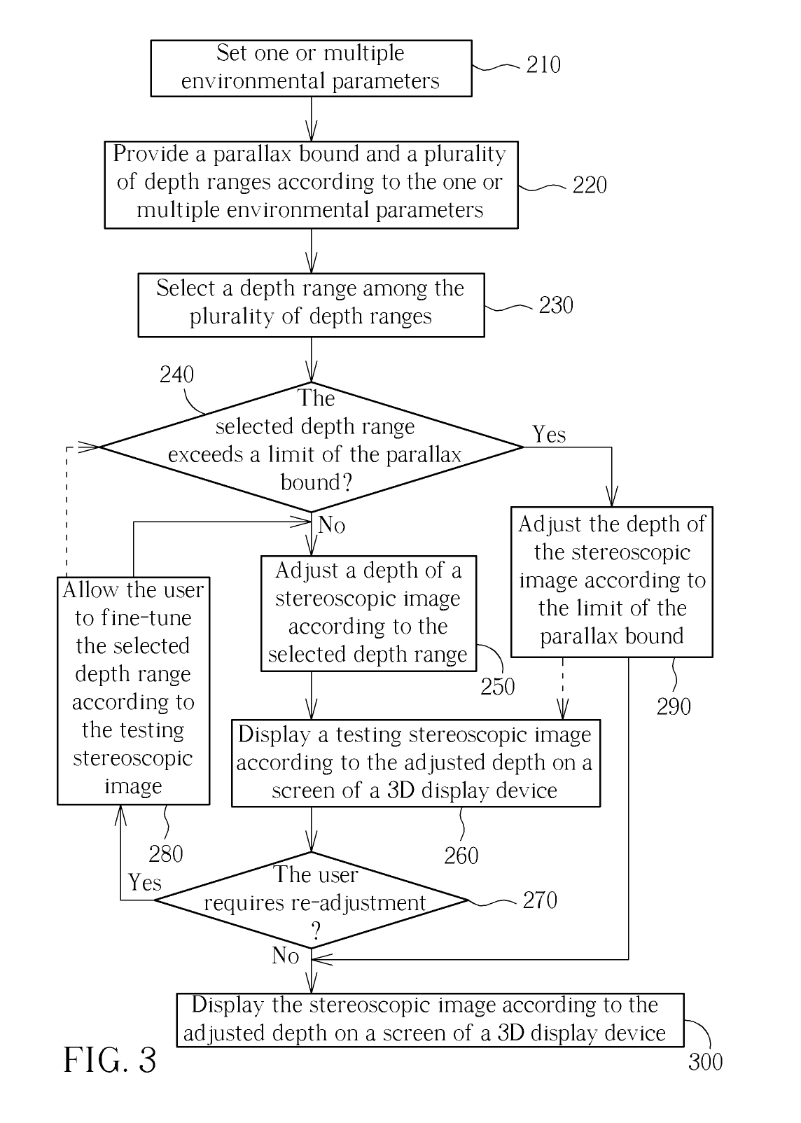

FIG. 3 is a flowchart illustrating a method for displaying stereoscopic images according to a second embodiment of the present invention. The present method in FIG. 3 includes the following steps:

Step 210: allow a user to set one or multiple environmental parameters; execute step 220;

Step 220: provide a parallax bound and a plurality of depth ranges according to the one or multiple environmental parameters; execute step 230;

Step 230: allow the user to select a depth range among the plurality of depth ranges; execute step 240;

Step 240: determine whether the selected depth range exceeds a limit of the parallax bound; if yes, execute step 290; if no, execute step 250;

Step 250: adjust a depth of a stereoscopic image according to the selected depth range; execute step 260;

Step 260: display a testing stereoscopic image according to the adjusted depth on a screen of a 3D display device; execute step 270;

Step 270: determine whether the user requires re-adjustment: if yes, execute step 280; if no, execute step 300;

Step 280: allow the user to fine-tune the selected depth range according to the testing stereoscopic image; execute step 250 or 240;

Step 290: adjust the depth of the stereoscopic image according to the limit of the parallax bound and the selected depth range; execute step 300 or 260;

Step 300: display the stereoscopic image according to the adjusted depth on the screen of the 3D display device.

Compared to the first embodiment illustrated in FIG. 2, the second embodiment illustrated in FIG. 3 further includes steps 260, 270 and 280. After it is determined in step 240 that the selected depth range does not exceed the limit of the parallax bound, step 250 is then executed for adjusting the depth of the stereoscopic image according to the selected depth range. Next, step 260 is executed for displaying a testing stereoscopic image according to the adjusted depth on the screen of the 3D display device. In step 270, the user may thus verify whether the displayed testing stereoscopic image provides a proper stereoscopic effect in the current viewing environment. If the testing stereoscopic image is not satisfactory, the user may choose to further fine-tune the selected depth range in step 280. The present method may then loop back to step 250 (or 240) until the user makes the verification in step 270. Finally, step 300 may be executed for displaying the stereoscopic images according to the adjusted depth on the screen of the 3D display device. After it is determined in step 240 that the selected depth range exceeds the limit of the parallax bound, step 290 is then executed for adjusting the depth of the stereoscopic image according to the limit of the parallax bound and the selected depth range. Next, step 300 (or 260) is executed.

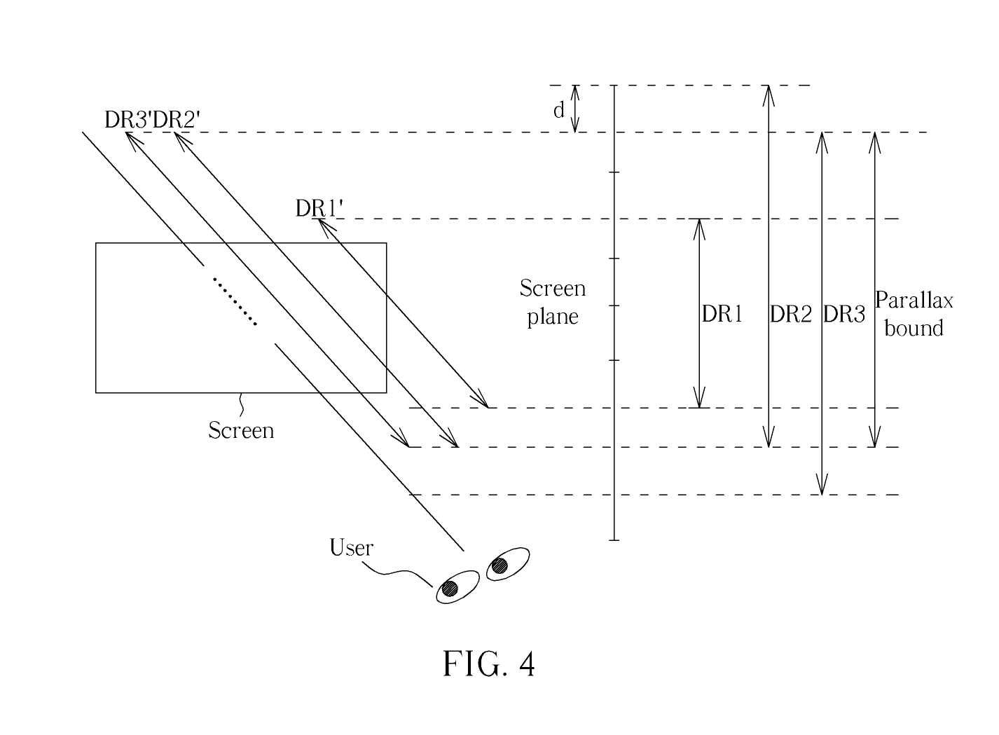

FIG. 4 is a diagram illustrating the method for displaying stereoscopic images according to the present invention. The parallax bound may be calculated in step 220 after the user sets one or more environmental parameters which may be associated with the optometric features of the user or the disposition of the 3D viewing environment. Assuming that the user has set the environmental parameter which is associated with his current viewing position in step 210, the plurality of depth ranges may be provided by equally sectioning the distance between the viewing location and the screen in step 220. For example, if the distance between the viewing location and the screen is 5d, a plurality of depth levels, five negative depth levels (in front of the screen plane) and five positive depth levels (behind the screen plane), each separated by a constant distance d are provided. A plurality of depth ranges may thus be defined by two depth levels among the five positive depth levels, the five negative depth levels and the zero depth level (screen plane). The user may then select a depth range among the plurality of depth ranges based on personal preference.

FIG. 4 illustrates three possible types of the selected depth range. The first type of the selected depth range DR1 is within the parallax bound, the second type of the selected depth range DR2 exceeds the parallax bound in the positive tuning range, and the third type of the selected depth range DR3 exceeds the parallax bound in the negative tuning range. After performing the present method, DR1′ -DR3′ represent the actual depth ranges associated with the three types of the selected depth ranges DR1-DR3, respectively. If the user has selected the depth level which exceeds the upper or lower limit of the parallax bound, the resultant depth ranges may still be restricted to the parallax bound using the present method, thereby avoiding causing visual discomforts.

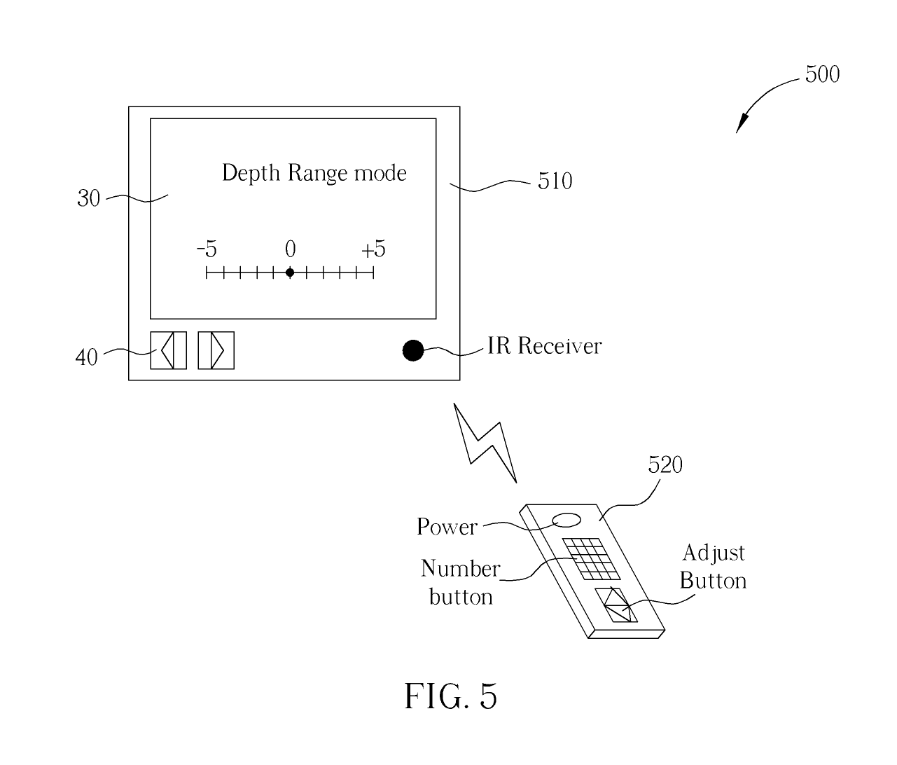

FIG. 5 is a diagram illustrating a 3D display system 500 according to the present invention. The 3D display system 500 includes a 3D display device 510 (e.g., LCD, PDP display . . . etc) and a remote controller 520. The user may set one or more environmental parameters using the remote controller 520 or a control panel 40 of the 3D display device 510. The control panel 40 may be implemented by a touch panel, button or others. The 3D display device 510 may calculate the corresponding plurality of depth levels using a depth adjusting module (not shown in FIG. 5) and then display the depth levels on a screen 30 of the 3D display device 510, thereby allowing the user to select a preferred depth range using the remote controller 520 or the control panel 40. If the user changes his position during a 3D presentation, or another user plans to watch a 3D presentation, the 3D display system 500 of the present invention can provide a customized depth for displaying stereoscopic images without causing visual discomforts.

The present invention may be used for in a two-view 3D display system or a multi-view 3D display system. In a multi-view 3D display system, more than two cameras are used for capturing the same scene from different viewpoints, thereby providing an interactive selection of viewpoint and direction within a certain operating range for a single individual or simultaneously for multiple viewers.

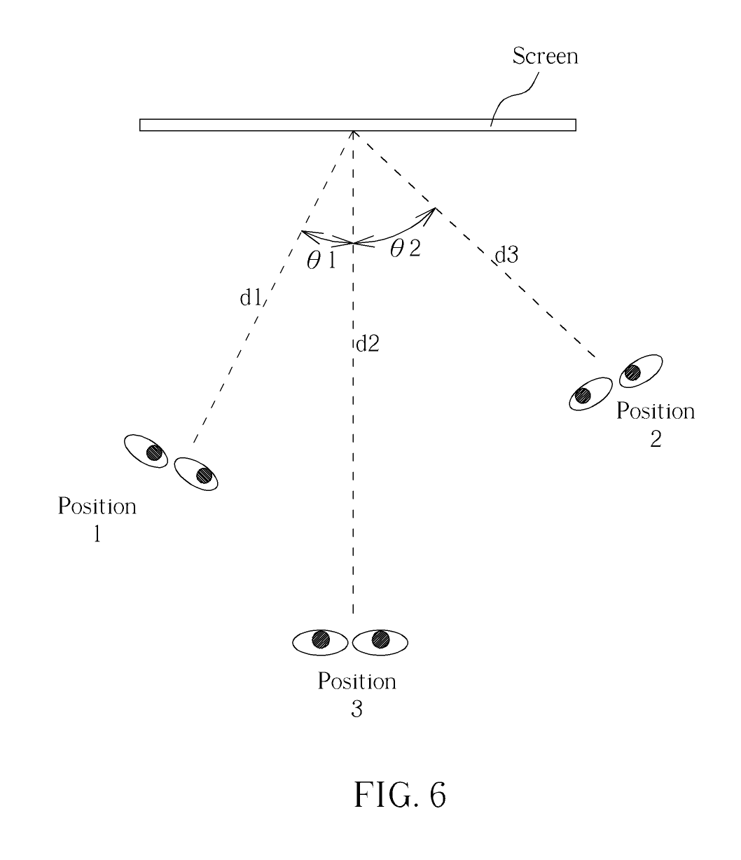

FIG. 6 is a diagram illustrating the present invention when used in a multi-view 3D display system. In one scenario, 3 users may simultaneously watch a 3D presentation at respective locations marked by Positions 1˜3 at the same time. The environmental parameters set in step 210 may be associated with the optometric feature and the current viewing position of each user (e.g., distances d1˜d3 between the positions 1˜3 to the center of the screen and the included angles 0, θ1 and θ2 between the positions 1˜3 to the perpendicular of the screen), thereby providing 3 adjusted depth ranges based on which stereoscopic images may be displayed for viewing at Positions 1˜3, respectively. In another scenario, a user may watch a 3D presentation at different locations marked by Positions 1˜3. The environmental parameters set in step 210 may be associated with the optometric feature and each viewing position of the user, thereby providing 3 adjusted depth ranges based on which stereoscopic images may be displayed for viewing at Positions 1˜3, respectively.

The present invention may display stereoscopic images without causing visual discomforts by adjusting display parameter based on the current viewing environment.

Those skilled in the art will readily observe that numerous modifications and alterations of the device and method may be made while retaining the teachings of the invention.

What is claimed is:

1. A method for displaying stereoscopic images comprising:
providing a parallax bound and a plurality of depth ranges according to at least one environmental parameter;
selecting a depth range among the plurality of depth ranges;
adjusting a depth of a stereoscopic image according to the parallax bound and the selected depth range; and
displaying the adjusted stereoscopic image on a screen.

2. The method of claim 1, further comprising:
adjusting the depth of the stereoscopic image into a preferred depth range obtained by restricting the selected depth range according to the parallax bound.

3. The method of claim 1, wherein the at least one environmental parameter includes an interpupillary distance.

4. The method of claim 1, wherein the at least one environmental parameter includes a distance between a viewing location and the screen, and the method further comprises providing a plurality of depth levels by equally sectioning the distance between the viewing location and the screen, wherein each depth range is defined by two depth levels among the plurality of depth levels.

5. A method for displaying multi-view stereoscopic images comprising:
providing two or more parallax bounds and two or more sets of depth ranges respectively according to two or more sets of at least one environmental parameter which are associated with different viewing locations respectively
selecting two or more depth ranges respectively from the two or more sets of depth ranges;
adjusting the depth of a multi-viewing stereoscopic image to be presented for each viewing location according to the two or more parallax bounds and the two or more selected depth ranges; and
displaying the adjusted multi-viewing stereoscopic image on a screen.

6. The method of claim 5, further comprising:
for each viewing location, adjusting the depth of the multi-view stereoscopic image into a preferred depth range, wherein the preferred depth range is obtained by restricting the selected depth range according to the corresponding parallax bound.

7. The system of claim 5, wherein the at least one environmental parameter includes an interpupillary distance.

8. The method of claim 5, wherein the at least one environmental parameter includes a distance between the viewing location and the screen, and the method further comprises providing a plurality of depth levels by equally sectioning the distance between the viewing location and the screen, wherein each depth range is defined by two depth levels among the plurality of depth levels.

9. A system for displaying stereoscopic images comprising:
an interface configured to allow a user to set at least one environmental parameter;
a depth adjusting module configured to provide the plurality of depth ranges and a parallax bound according to the at least one environmental parameter and adjust a depth of a stereoscopic image according to the parallax bound and the selected depth range; and
a screen configured to display the adjusted stereoscopic image.

10. The system of claim 9, wherein the at least one environmental parameter includes an interpupillary distance.

11. The system of claim 9, wherein the at least one environmental parameter includes a distance between a viewing location and the screen, and the depth adjusting module further provides the parallax bound and a plurality of depth levels by equally sectioning the distance between the viewing location and the screen, wherein each depth range is defined by two depth levels among the plurality of depth levels.

12. The system of claim 9, wherein the depth adjusting module is configured to obtain a preferred range for the stereoscopic image by limiting the selected depth range to the parallax bound.

13. The system of claim 12, wherein the depth adjusting module is configured to adjust the depth of the stereoscopic image by referring to the preferred range.
